(19) United States
(12) Patent Application Publication
(10) Pub. No.: US 2021/0350554 A1
(43) Pub. Date: Nov. 11, 2021

(54) EYE-TRACKING SYSTEM

(71) Applicant: Tobii AB, Danderyd (SE)

(72) Inventors: David Masko, Danderyd (SE); Mark Ryan, Danderyd (SE); Mattias Kuldkepp, Danderyd (SE)

(73) Assignee: Tobii AB, Danderyd (SE)

(21) Appl. No.: 17/219,334

(22) Filed: Mar. 31, 2021

(30) Foreign Application Priority Data
Mar. 31, 2020 (SE) 2030111-5

(51) Int. Cl. G06T 7/254; G06T 7/246; G06K 9/00; G06N 20/00

(52) U.S. Cl. CPC G06T 7/254; G06T 7/248; G06T 2207/20081; G06N 20/00; G06T 2207/20224; G06K 9/00597

(57) ABSTRACT

An eye-tracking system configured to: receive a reference-image of an eye of a user, the reference-image being associated with reference-eye-data; receive one or more sample-images of the eye of the user; and, for each of the one or more sample-images: determine a difference between the reference-image and the sample-image to define a corresponding differential-image; and determine eye-data for the sample-image based on the differential-image and the reference-eye-data associated with the reference-image.

### CROSS-REFERENCE TO RELATED APPLICATION

The present application claims benefit to Swedish patent application No. 2030111-5, filed Mar. 31, 2020, entitled “Method, Computer Program Product and Processing Circuitry for Pre-Processing Visualizable Data”, and is hereby incorporated by reference in its entirety.

### TECHNICAL FIELD

The present disclosure generally relates to the field of eye tracking. In particular, the present disclosure relates to systems and methods that determine differential-images for use in eye-tracking.

### BACKGROUND

In eye tracking applications, digital images are retrieved of the eyes of a user and the digital images are analysed in order to estimate the gaze direction of the user. The estimation of the gaze direction may be based on computer-based image analysis of features of the imaged eye. Many eye-tracking systems estimate gaze direction based on identification of a pupil position, sometimes together with glints or corneal reflections. Therefore, accuracy in the estimation of gaze direction may depend upon an accuracy of the identification or detection of the pupil position and/or the corneal reflections. One or more spurious image features such as stray reflections may be present in the digital images which can detrimentally affect eye feature identification.

One known example method of eye tracking includes the use of infrared light and an image sensor. The infrared light is directed towards the pupil of a user and the reflection of the light is captured by an image sensor.

Portable or wearable eye tracking devices have also been previously described. One such eye-tracking system is described in U.S. Pat. No. 9,041,787 (which is hereby incorporated by reference in its entirety). A wearable eye tracking device is described using illuminators and image sensors for determining gaze direction.

### SUMMARY

According to a first aspect of the invention there is provided an eye-tracking system configured to:
receive a reference-image of an eye of a user, the reference-image being associated with reference-eye-data;
receive one or more sample-images of the eye of the user; and
for each of the one or more sample-images:
   determine a difference between the reference-image and the sample-image to define a corresponding differential-image; and
   determine eye-data for the sample-image based on the differential-image and the reference-eye-data associated with the reference-image.

Determining eye-data based on differential-images instead of directly on the sample-images can result in improved accuracy and precision of the eye-data and/or reduced computational requirements of the system.

The reference-eye-data may comprise reference-gaze-data. The eye-data may comprise gaze-data.

The reference-gaze-data may comprise gaze-origin-data and/or gaze-direction-data. The gaze-data may comprise gaze-origin-data and/or gaze-direction-data.

The reference-image may comprise an image acquired by the eye-tracking system when a stimulus was presented to the user at a predetermined location. The reference-gaze-data may correspond to a gaze point associated with the predetermined location.

The stimulus may be presented to the user at a predetermined location on a display of the eye-tracking system.

The eye-tracking system may be configured to determine eye-data for the sample-image using a machine learning eye-tracking-algorithm.

The machine learning eye-tracking-algorithm may be trained using differential-training-images defined as a difference between a reference-training-image with known reference-training-data and corresponding training-images with known training-eye-data.

The reference-eye-data may comprise reference-pupil-data. The eye-data may comprise pupil-data.

The reference-pupil-data may comprise a pupil-position and/or a pupil-radius. The pupil-data may comprise a pupil-position and/or a pupil-radius.

The reference-image may comprise an image of the eye of the user for which a pupil-detection process has determined the reference-pupil-data with a confidence-value exceeding a confidence-threshold.

The eye-tracking system may be further configured to:
perform a pupil-detection process on one or more initial-images of the eye of the user to determine reference-pupil-data associated with each initial-image, each reference-pupil-data having an associated confidence-value; and
select the reference-image from the one or more initial-images based on the confidence-values of the pupil-data.

The eye-tracking system may be configured to determine the pupil-data for the sample-image based on the differential-image and the reference-pupil-data associated with the reference-image by:
determining a candidate region of the sample-image for performing a pupil-detection process based on the corresponding differential-image and the reference-pupil-data associated with the reference-image; and
performing the pupil-detection process on the candidate region of the sample-image to determine the pupil-data of the sample-image.

The reference-pupil-data may comprise a pupil-area. The reference-image and each sample-image may comprise a pixel-array of pixel-locations, each pixel-location having an intensity-value. The eye-tracking system may be configured to determine the difference between the reference-image and the sample-image by matrix subtraction of the corresponding pixel-arrays to define the differential-image as a pixel-array of differential-intensity-values. The eye-tracking system may be configured to determine the candidate region of the sample-image by:
determining candidate-pixel-locations of the corresponding differential-image based on the pupil-area and the differential-intensity-values; and
determine the candidate region of the sample-image corresponding to the candidate-pixel-locations of the differential-image.

The eye-tracking system may be configured to determine the candidate-pixel-locations of the differential-image as:
pixel-locations of the differential-image that correspond to the pupil-area and have a differential-intensity-value representing substantially similar intensity-values of the pixel-location in the corresponding sample-image and the reference-image; and/or
pixel-locations of the differential-image that do not correspond to the pupil-area and have a differential-intensity-value representing a lower intensity-value of the pixel-location in the corresponding sample-image relative to the reference-image.

A resolution of the differential-image may be less than a resolution of the corresponding sample-image.

The reference-image may be one of a plurality of reference-images, each reference-image having associated reference-eye-data. The eye-tracking system may be configured to:
receive the plurality of reference-images of the eye of the user; and
for each of the one or more sample-images:
   determine a difference between each of the plurality of reference-images and the sample-image to define a plurality of differential-images; and
   determine the eye-data for the sample-image based on the plurality of differential-images and the reference-eye-data associated with each of the plurality of reference-images.

The eye-tracking system may be configured to determine the eye-data for the sample-image based on the plurality of differential-images and the reference-eye-data associated with each of the plurality of reference-images by:
for each of the one or more sample-images:
   determining intermediate-eye-data for each differential-image based on the differential-image and the reference-eye-data of the reference-image corresponding to the differential-image; and
   calculating the eye-data based on the each intermediate-eye-data.

The eye-tracking system may be configured to calculate the eye-data based on an average of the intermediate-eye-data.

Each reference-eye-data may have an associated confidence-value. The eye-tracking system may be configured to:
determine weighted-intermediate-eye-data for each intermediate-eye-data based on the confidence-value of the corresponding reference-eye-data; and
calculate the eye-data as a sum of the weighted-intermediate-eye-data.

The eye-tracking system may be further configured to remove outlier intermediate-eye-data.

According to a second aspect of the invention, there is provided a head-mounted device comprising any eye-tracking system disclosed herein.

The head-mounted device may comprise a display capable of presenting graphics to a user. The head-mounted device may comprise an extended reality (XR) device. The display may be transparent, for example in an augmented reality (AR) device. The display may be non-transparent, for example in a virtual reality (VR) device. In other examples, the head-mounted device may not comprise a display, for example in glasses for eye-tracking.

According to a second aspect, there is provided a head-mounted device comprising any eye-tracking system disclosed herein.

The head-mounted device may comprise a display capable of presenting graphics to a user. The head-mounted device may comprise an extended reality (XR) device. The display may be transparent, for example in an augmented reality (AR) device. The display may be non-transparent, for example in a virtual reality (VR) device. In other examples, the head-mounted device may not comprise a display, for example in glasses for eye-tracking.

According to a further aspect of the invention there is provided a method for eye-tracking, the method comprising:
receiving a reference-image of an eye of a user, the reference-image being associated with reference-eye-data;
receiving one or more sample-images of the eye of the user; and
for each of the one or more sample-images:
   determining a difference between the reference-image and the sample-image to define a corresponding differential-image;
   determining eye-data for the sample-image based on the differential-image and the reference-eye-data associated with the reference-image.

According to a yet further aspect of the present invention there is provided a method of providing an eye-tracking-algorithm, the method comprising:
receiving a reference-training-image of an eye of a user, the reference-training-image being associated with reference-training-data;
receiving a plurality of training-images of the eye of the user, each training-image being associated with training-eye-data;
determining a difference between the reference-training-image and each of the training-images to define corresponding differential-training-images;
training the eye-tracking-algorithm based on the differential-training-images, the reference-training-data and the training-eye-data associated with the corresponding training-images.

The eye-tracking-algorithm may be a gaze-tracking-algorithm. The reference-training-data and the training-eye-data may comprise gaze-data.

The eye-tracking-algorithm may be a pupil-tracking-algorithm.

There may be provided a computer program, which when run on a computer, causes the computer to configure any apparatus, including a circuit, controller, converter, or device disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an internet download. There may be provided one or more non-transitory computer-readable storage media storing computer-executable instructions that, when executed by a computing system, causes the computing system to perform any method disclosed herein.

### BRIEF DESCRIPTION OF THE DRAWINGS

There now follows, by way of example only, a detailed description of embodiments of the invention with reference to the following figures, in which:

FIG. 1 shows a schematic view of an eye-tracking system which can be used to capture a sequence of images for use by example embodiments;

FIG. 2A shows a simplified example image of an eye;

FIG. 2B shows another simplified example image of an eye;

FIG. 3 shows an example of an eye-tracking system according to an embodiment of the present disclosure;

FIG. 4 illustrates how differential-images can be calculated from corresponding sample-images and a reference-image by an eye-tracking system according to an embodiment of the present disclosure;

FIG. 5 illustrates a reference-image, two sample-images and two corresponding differential-images that may be calculated by an eye-tracking system configured to determine gaze-data according to an embodiment of the present disclosure;

FIG. 6 illustrates two differential-images calculated by an eye-tracking system configured to determine pupil-data according to an embodiment of the present disclosure;

FIG. 7 is a flow chart of an example of a method for eye-tracking according to an embodiment of the present disclosure; and

FIG. 8 is a flow chart of a method for training an eye-tracking-algorithm according to an embodiment of the present disclosure.

All the figures are schematic and generally only show parts which are necessary in order to elucidate the respective embodiments, whereas other parts may be omitted or merely suggested.

### DETAILED DESCRIPTION

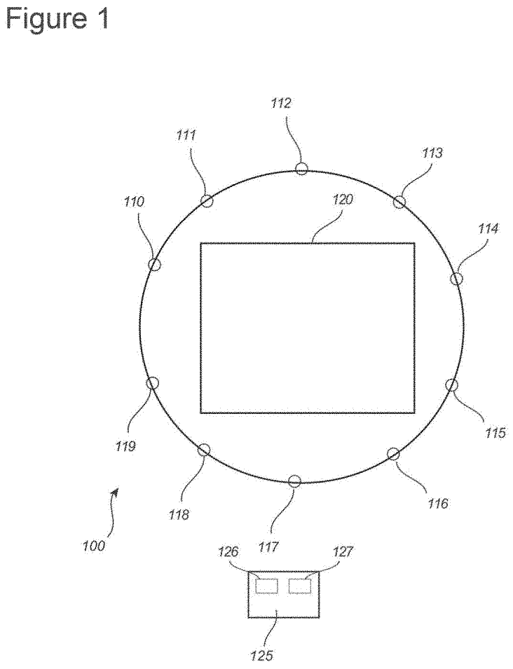

FIG. 1 shows a simplified view of an eye-tracking system 100 (which may also be referred to as a gaze tracking system) in a head mounted device in the form of a virtual or augmented reality (VR or AR) device or VR or AR glasses. The system 100 comprises an image sensor 120 (e.g. a camera) for capturing images of the eyes of the user. The system may optionally include one or more illuminators 110-119 for illuminating the eyes of a user, which may for example be light emitting diodes emitting light in the infrared frequency band, or in the near infrared frequency band and which may be physically arranged in a variety of configurations. The image sensor 120 may for example be an image sensor of any type, such as a complementary metal oxide semiconductor (CMOS) image sensor or a charged coupled device (CCD) image sensor. The image sensor may consist of an integrated circuit containing an array of pixel sensors, each pixel containing a photodetector and an active amplifier. The image sensor may be capable of converting light into digital signals. In one or more examples, it could be an Infrared image sensor or IR image sensor, a Near Infrared, NIR, image sensor, an RGB sensor, an RGBW sensor or an RGB or RGBW sensor with IR filter, or any combination thereof.

The eye-tracking system 100 may comprise circuitry or one or more controllers 125, for example including a receiver 126 and processing circuitry 127, for receiving and processing the images captured by the image sensor 120. The circuitry 125 may for example be connected to the image sensor 120 and the optional one or more illuminators 110-119 via a wired or a wireless connection and be co-located with the image sensor 120 and the one or more illuminators 110-119 or located at a distance, e.g. in a different device. In another example, the circuitry 125 may be provided in one or more stacked layers below the light sensitive surface of the light sensor 120.

The eye-tracking system 100 may include a display (not shown) for presenting information and/or visual stimuli to the user. The display may comprise a VR display which presents imagery and substantially blocks the user's view of the real-world or an AR display which presents imagery that is to be perceived as overlaid over the user's view of the real-world.

The location of the image sensor 120 for one eye in such a system 100 is generally away from the line of sight for the user in order not to obscure the display for that eye. This configuration may be, for example, enabled by means of so-called hot mirrors which reflect a portion of the light and allows the rest of the light to pass, e.g. infrared light is reflected, and visible light is allowed to pass. However, other solutions are applicable, such as using diffractive optical elements, DOE, such that the image sensor 120 and/or illuminators 110-119 can be positioned arbitrary in the head mounted device and still be able to capture (or illuminate) an eye of the user.

While in the above example the images of the user's eye are captured by an image sensor 120 comprised in the head mounted device, due to it forming part of the eye-tracking system 100, the images may alternatively be captured by an image sensor separate from an eye-tracking system 100 wherein said image sensor 120 may be comprised in the head mounted device or not. The size and the position of the image sensor 120 in FIG. 1 are not representative of the actual size and the actual position of the image sensor 120. As mentioned above, the position of the image sensor 120 is preferably not in line of sight for the user in order not to obscure the display for that eye. For example, the image sensor 120 may be positioned in the vicinity of one of the illuminators 110-119. Further, the image sensor 120 can be smaller than 1 mm in diameter, between 1 mm and 1 cm in diameter, or larger than 1 cm in diameter.

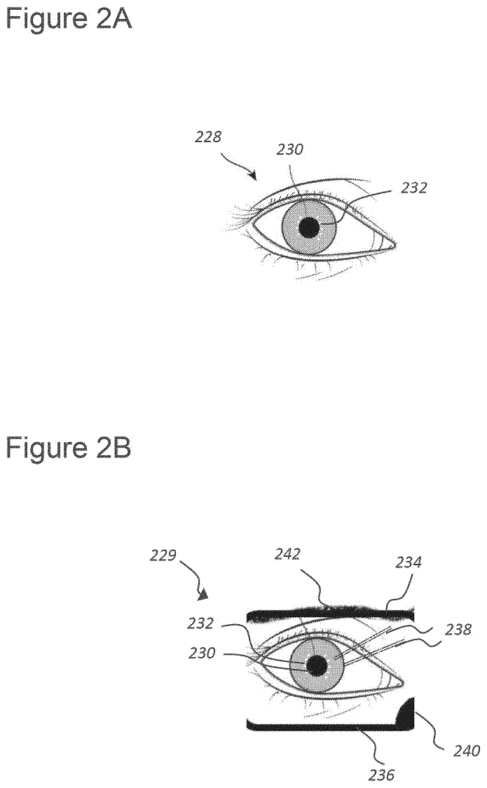

FIG. 2A shows a simplified example of an image of an eye 228, captured by an eye-tracking system such as the system of FIG. 1. A controller of the system may employ image processing (such as digital image processing) for extracting features in the image. The controller may for example identify the location of the pupil 230 in the one or more images captured by the image sensor. The controller may determine the location of the pupil 230 using a pupil-detection process. The controller may also identify corneal reflections 232 or glints in the image of the eye. The corneal reflections may correspond to reflections of light emitted by one or more illuminators of the eye-tracking system. The controller may estimate a corneal centre based on the corneal reflections 232. The controller may determine gaze data, such as gaze origin or gaze direction based on the image of the eye. For example, the controller may determine gaze data based on the corneal reflections 232 and the location of the pupil 230.

FIG. 2B shows a further simplified example of an image of an eye 229, captured by an eye-tracking system such as the system of FIG. 1. In this example, the image 229 comprises spurious features that can detrimentally affect identification of the pupil 230 leading to an inaccurate determination of gaze direction. The spurious features in this example include: an upper portion 234 of a frame of spectacles; a lower portion 236 of the frame; stray reflections 238 from a lens of the spectacles; a nose piece 240 (which could be from the spectacles or a head mounted device); and an eyebrow 242. Other examples of spurious image features include mascara, tattoos, freckles, shadows etc.

One or more spurious image features may detrimentally affect an estimation of gaze direction. For example, the controller may erroneously identify a dark region such as the nose piece 240 as a pupil. The controller may also erroneously identify stray reflections 238 as corneal reflections.

In a head mounted system, in particular, the position of the spurious features in a sequence of images image 229 may remain fixed even as a user moves their head and/or eyes. One or more other regions of the sequence of images, such as a user's cheek or forehead, may also remain substantially static and maintain a substantially constant intensity-value or brightness value. In contrast, the pupil position and cornea position will change in the sequence of images as the user changes their gaze direction. As a result, pixel-locations corresponding to the pupil or corneal reflections in a particular image will vary in intensity over the sequence of images as the pupil moves to other pixel-locations.

The present disclosure relates to systems and methods for enhancing performance of a user-facing camera in eye-tracking systems. As will be described in detail below, examples can use a keyframe image and define differential-images using the keyframe image. The keyframe image may be captured in a way or at a time such that it can be associated with additional information. This additional information can be referred to as reference-data and can be related to eye-data from the image or data from the scene that the camera is monitoring. In this way, the keyframe image can be considered as an information pair comprising a reference-image and associated reference-data. The terms keyframe image and reference-image can be considered synonymous and may be used interchangeably throughout this disclosure.

The eye-tracking system can define a differential-image as a difference between the reference-image and a sample-image captured at a later time. The eye-tracking system may then determine external-data, such as eye-data, for the sample-image based on the differential-image and the reference-data associated with the reference-image. The reference-data and/or external-data may comprise eye-data such as gaze-data or pupil-data.

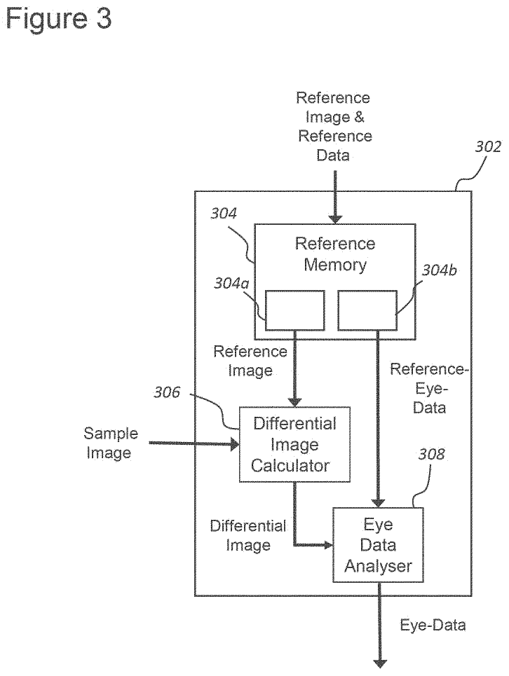

FIG. 3 shows an example of an eye-tracking system 302 according to an embodiment of the present disclosure. The functionality that is illustrated in FIG. 3A may be provided by one or more controllers. The eye-tracking system may be part of, or associated with, a head-mounted device or a remote system. It will be appreciated that the various modules of the eye-tracking system 302 that are described below may be embodied in software or hardware.

The eye-tracking system 302 receives a reference-image of an eye of a user. The reference-image may be of one or both eyes of a user and may comprise facial areas surrounding one or both eyes. In one or more examples, the eye-tracking system 302 may process or crop the reference-image such that it comprises eye-features of only one eye.

The reference-image is associated with reference-data, which in this example is reference-eye-data. As discussed further below, the reference-eye-data may relate to known eye-data such as a known pupil-position or a known gaze-direction. As used herein, “known” may relate to eye-data determined with a confidence-value higher than a confidence-threshold, for example 95%, or eye-data determined with an error-value less than an error-threshold, for example 5%. The confidence-value or error-value may relate to an accuracy and/or precision value of the reference-eye-data. The term “known” may also relate to an assumed value for eye-data that corresponds to a visual stimulus presented to the user at a predetermined location when the reference-image was captured, wherein it is assumed that the user was looking at the visual stimulus when the reference-image was captured.

In this example, the eye-tracking system can store the reference-image in a reference-memory 304. The reference-memory 304 may store the reference-image in a reference-image-memory 304a and the associated reference-eye-data in reference-data-memory 304b.

The eye-tracking system 302 also receives a sample-image of the eye of the user. The eye-tracking system 302 can receive the sample-image at a differential-image-calculator 306. The differential-image-calculator 306 can also receive the reference-image from the reference-image-memory 304a. The differential-image-calculator 306 determines a difference between the reference-image and the sample-image to define a differential-image.

As disclosed herein, an image of an eye of a user, such as the reference-image or the sample-image, may comprise a digital image produced by an image sensor. The image may equivalently be referred to as an image frame or frame. The image may comprise a pixel-array. The pixel-array may comprise a plurality of pixel-locations and an intensity-value at each of the pixel-locations. In some examples, the pixel-array may comprise a two-dimensional array of pixel-locations. The differential-image-calculator 306 may determine the difference between the reference-image and the sample-image by matrix subtraction of the corresponding pixel-arrays. In other words, the differential-image-calculator 306 determines the difference between intensity-values at corresponding pixel-locations in the reference-image and the sample-image. The resultant pixel-array of differential-intensity-values can then define the differential-image.

As discussed below, in some examples the differential-image-calculator 306 may sample the reference-image and the sample-image such that the differential-image has a lower resolution than the sample-image. This can improve a processing speed of the eye-tracking system, for example in the calculation of differential-images and/or the subsequent determination of eye-data of sample-images.

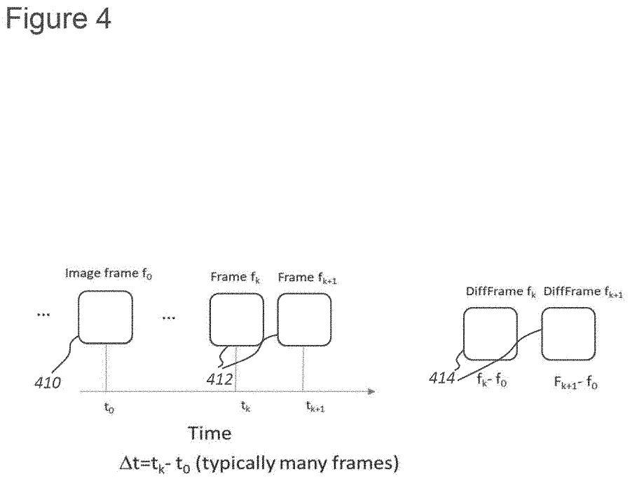

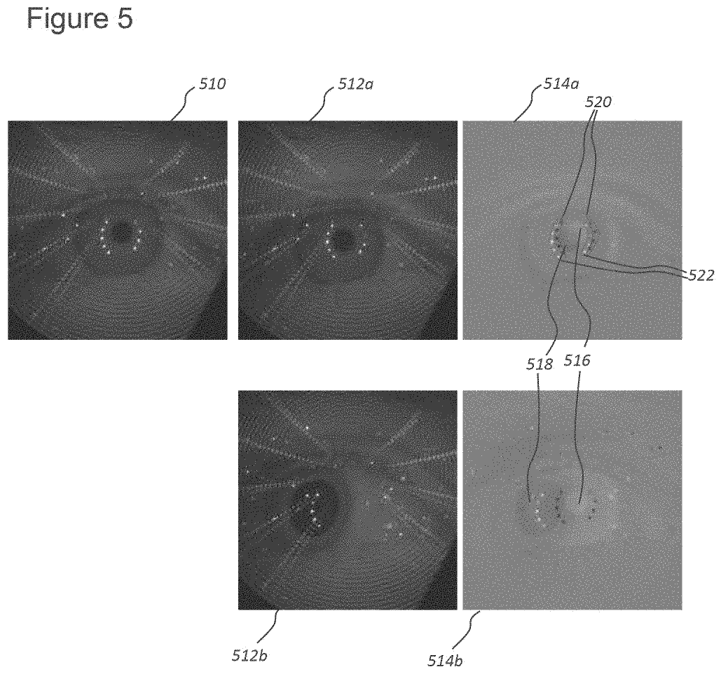

In this example, the eye-tracking system 302 comprises an eye-data-analyser 308 which receives the differential-image from the differential-image-calculator 306 and receives the reference-eye-data from the reference-data-memory 304b. The eye-data-analyser 308 can determine eye-data for the sample-image based on the differential-image and the reference-eye-data associated with the reference-image. Determining eye-data based on differential-images instead of “raw” sample-images can result in improved accuracy and precision of the eye-data and/or reduced computational requirements of the system. This is because, as will be explained further below with reference to FIGS. 4 and 5, differential-images can enhance important features for eye-tracking, such as pupil-position and corneal reflections and their relative movement. In addition, static artefacts are less prominent in differential-images.

In some examples, the eye-tracking system 302 may receive a plurality of reference-images, each having their own associated reference-data.

In some examples, the eye-tracking system 302 may select a reference-image from the plurality of reference-images based on their associated reference-data. For example, the reference-image may be selected based on a confidence-value or error-value of the associated reference-data. In this way, the reference-image with the highest confidence-value can be selected which can result in more accurate determination of eye-data for the sample-images.

In other examples, the differential-image-calculator 306 of the eye-tracking system may determine a difference between the sample-image and each of the plurality of reference-images to define a plurality of differential-images. The eye-data-analyser 308 may then determine eye-data for the sample-image based on the plurality of differential-images and the reference-eye-data associated with each of the plurality of reference-images. In this way, the sample-image is associated with a plurality of differential-images.

In some examples, the eye-data-analyser 308 may, for a sample-image, determine intermediate-eye-data for each differential-image based on the reference-eye-data corresponding to the reference-image used to define the differential-image. The eye-data of the sample-image may then be determined based on the plurality of intermediate-eye-data. For example, the intermediate-eye-data may be averaged, or outliers may be excluded, to determine the eye-data of the sample-image. A weighted-average may be applied to the intermediate-eye-data with weights based on confidence-values associated with the respective reference-images. The use of intermediate-eye-data can enable a plurality of reference-images and their associated reference-eye-data to be used in the determination of eye-data of a sample-image. The additional processing of averaging, removal of outliers etc can result in more accurate determination of the eye-data.

FIG. 4 illustrates how a stream of differential-images can be calculated from a corresponding stream of sample-images and a reference-image.

At time t₀, the eye-tracking system receives a reference-image, f₀, 410 of an eye of a user. The reference-image 410 is associated with external data such as reference-eye-data (not shown). The reference-eye-data may comprise any eye-data representative of the reference-image, for example a known pupil-position or a known gaze-direction. The eye-tracking system receives sample-images, fₖ, fₖ₊₁, 412 at later times tₖ, tₖ₊₁. The sample-images 412 may comprise images of the eye of the user with no external data, or for which the eye-data type contained in the reference-eye-data is unknown. For example, if the reference-eye-data comprises reference-pupil-data in the form of a pupil position, the pupil-position of the sample-images 412 may be unknown. The eye-tracking system may receive the sample-images 412 at any time after receiving the reference-image 410, for example immediately following; multiple frames later; or in a separate eye-tracking session or operation.

The eye-tracking system defines differential-images, fₖ-f₀, fₖ₊₁-f₀, 414 as a difference between a corresponding sample-image 412 and the reference-image 410. The differential-images 414 may define a differential stream of images. In some examples, the eye-tracking system may maintain a resolution of the reference-image 410 and the sample-image 412 such that a resolution of the differential-image 414 is the same as a resolution of the corresponding sample-image 412. In other examples, the eye-tracking system may sample the reference-image 410 and/or the sample-image 412 before determining the differential-image 414 such that a resolution of the differential-image 414 is less than a resolution of the corresponding sample-image 412.

The stream of differential-images 414 can then be used to determine values for the eye-data for the sample-images 412, for example, using the eye-data-analyser 308 of FIG. 3.

FIG. 5 illustrates a reference-image 510, two sample-images 512a, 512b and two corresponding differential-images 514a, 514b that may be calculated by an eye-tracking system configured to determine gaze-data according to an embodiment of the present disclosure.

In this example, the reference-eye-data and the eye-data both comprise gaze-data, for example gaze-origin-data and/or gaze-direction-data. The eye-tracking system receives a reference-image 510. The reference-image 510 may comprise an image acquired by the eye-tracking system when a stimulus was presented to a user at a predetermined location. The stimulus may be presented on a screen of the eye-tracking system or on a physical target separate to the eye-tracking hardware. The reference-gaze-data associated with the reference-image 510 may correspond to a gaze point associated with the stimulus. For example, the reference-gaze-data may comprise a gaze-direction representing the vector between the eye of the user and the stimulus point. The reference-gaze-data may alternatively or additionally comprise a gaze-origin based on a position of a cornea of the eye of the user when viewing the stimulus point. In some examples, a plurality of stimulus points each corresponding to a different gaze point may be presented to the user in sequence to define a plurality of reference-images 510 and associated reference-gaze-data.

In this example, the reference-image 510 represents a calibration image captured by an image sensor of a head-mounted eye-tracking system in a VR device when the user is observing a central (0,0) stimuli point on a display screen. The reference-image comprises multiple spurious features (image artefacts), including: reflections from a Fresnel lens of the system, a lens cup, stray reflections from spectacles and also less important information (for gaze determination) like skin around the eyes, eyebrows, eyelashes etc.

The eye-tracking system receives sample-images 512a, 512b. The eye-tracking system may capture the sample-images 512a, 512b during an eye- or gaze-tracking operation, when a gaze of the user is unknown. The eye-tracking system can define differential-images 514a, 514b as a difference between the reference-image 510 and a corresponding sample-image 512a, 512b, as described above.

The eye-tracking system defines a differential-images 514a, 514b as a difference between the reference-image 510 and the corresponding sample-images 512a, 512b. In this example, the eye-tracking system defines the differential-images 514a, 514b by performing a matrix subtraction of the reference-image 510 from the corresponding sample-image 512a, 512b. In this example, the eye-tracking system defines and applies a scalar offset to avoid negative differential-intensity-values in the differential-images 514a, 514b. In this way, grey pixel-locations of the illustrated differential-images 514a correspond to minimal intensity-differences between the reference-image 510 and sample-image 512a, 512b. Black pixel-locations correspond to pixel-locations which are darker (lower intensity-value) in the sample-image 512a, 512b than the reference-image 510. White pixel-locations correspond to pixel-locations that are brighter (higher intensity-value) in the sample-image 512a, 512b than the reference-image 510.

The differential-image highlights eye-features that can be useful for eye-gaze-determination. In this example, a reference-pupil-area 516 corresponding to a pupil-position in the reference-image 510 can be identified in the differential-images 514a, 514b as a lighter circular region. A sample-pupil-area 518 corresponding to a pupil-position in the sample-image 512 can be identified in the differential-images 514a, 514b as a black circular region. In addition, reference-glints 520 corresponding to corneal-reflections in the reference-image can be identified as a group of black points lying either side of the reference-pupil-area 516 on a circular-path. Sample-glints 522 corresponding to corneal-reflections in the sample-image 512a, 512b can be identified as a group of white points offset from the reference-glints and lying on a circular-path. The eye-data-analyser can readily identify these distinct features and determine relative differences in corneal reflections (glints) and/or pupil-positions between the reference-image 510 and the corresponding sample-image 512. In some examples, the eye-tracking-analyser can determine gaze-data and/or pupil-data of the sample-image 512a, 512b based on the relative differences between the pupil-positions and/or corneal reflections 520, 522 and the known reference-eye-data. It can be seen from the Figure that the pupil in the first set of images 512a, 514a has moved in both a horizontal direction and a vertical direction. It can also be seen from the Figure that the pupil in the second set of images 512b, 514b has moved significantly in a horizontal direction. The pupil-radius has also increased significantly which may result from a change in lighting conditions.

As discussed above, the eye-tracking system can determine eye-data for the sample-images 512a, 512b based on the corresponding differential-images 514a, 514b and the reference-eye-data associated with the reference-image 510. In particular, the eye-tracking system can determine gaze-data for the sample-images 512a, 512b based on the differential-images 514a, 514b and the reference-gaze-data corresponding to the central stimulus point (0,0).

Eye-gaze-tracking systems can utilize machine learning (ML) networks (such as deep learning networks) with images as input to the network. The disclosed systems and methods can pre-process images by subtracting one or more reference-images from subsequently received images to create new differential-images as input for the network. Such systems can then use the pre-processed (differential) images to calculate eye-data in any way that is known in the art. The one or more reference-images may be captured during a personal calibration with known stimuli points. Systems and methods employing differential-images can be used to both: (i) train a ML network eye-tracking-algorithm; and (ii) determine unknown eye-data for sample-images.

In one or more examples, the systems and method of the disclosure may be used to train a gaze-tracking-algorithm comprising a ML network. A training method may comprise receiving a reference-training-image of an eye of a user. The reference-training-image may be associated with known reference-gaze-data, for example, by corresponding to an image captured when the user is presented with a stimulus at a predetermined location. The training method may further comprise receiving a plurality of training-images of the eye of the user. In a similar manner to the reference-training-image, each training-image is associated with known training-gaze-data. For example, the training-images may be captured by an eye-tracking system when the user is presented with a corresponding stimulus at different predetermined locations. The training-gaze-data may then correspond to gaze points associated with the different locations, for example a gaze-direction corresponding to a vector between the user's eye and the predetermined location.

The training method can define a plurality of differential-training-images by determining a difference between each training-image and the reference-training-image. These differential-training-images would be similar to the differential-images 514a, 514b of FIG. 5, but with known training-gaze-data. The plurality of differential-training-images corresponding to known training-gaze-data can be used to train the ML network of the gaze-tracking-algorithm. The change in pupil position and/or the corneal reflections that are clearly visible in the differential-images can be used to train the gaze-tracking algorithm. The enhancement of the pupil position and corneal reflections and the reduction of static spurious features can lead to a more accurate algorithm. The training method comprises training the eye-tracking-algorithm based on the differential-training-images, the reference-gaze-data and the training-gaze-data associated with the corresponding training-images.

After a ML network eye-tracking-algorithm has been trained with differential-training-images, the algorithm may be subsequently used in the systems and methods disclosed herein to determine unknown eye-data of a sample-image. The eye-data can be determined based on a differential-image and reference-eye-data as described above. Although the above discussion describes the training of an eye-gaze-tracking algorithm, the eye-tracking-algorithm may also be a pupil-tracking-algorithm or a pupil-detection process.

Returning to the example of FIG. 5, the eye-data-analyser of the eye-tracking system may determine gaze-data of the sample-images 512a, 512b based on the corresponding differential-images 514a, 514b and the known reference-gaze-data of the reference-image 510, using a ML gaze-tracking-algorithm. The gaze-tracking-algorithm may have been trained using a differential-training-image method as described above. In the example of FIG. 5, the eye-tracking system may determine a gaze-direction of the first sample-image 512a as corresponding to a 10-degree horizontal and 10-degree vertical offset from a known reference-gaze-direction corresponding to the central stimulus point (0,0). Similarly, the eye-tracking system may determine a gaze-direction of the second sample-image 512b as corresponding to a 30-degree horizontal offset. The offsets are determined using the differential-images 514a, 514b, the known reference-gaze-direction (corresponding to stimulus (0,0)) and the trained ML gaze-tracking-algorithm. In some examples, determining an eye-gaze may comprise an intermediate step of determining pupil-data, such as pupil-position. In such examples, the reference-gaze-data may comprise reference-pupil-data and the eye-data-analyser may determine pupil-data of the sample-image based on the differential-image and the reference-gaze-data using a ML eye-tracking-algorithm.

In the one or more gaze-tracking examples, the reference-image 510 can be considered as an anchor image for gaze-data. The eye-tracking system effectively encodes the reference-gaze-data associated with the reference-image 510 into the differential-images 514a, 514b by defining them as the difference between the corresponding sample-images 512a, 512b and the reference-image 510. As noted above, the described eye-tracking system and training method can be extended to receive a plurality of reference-images corresponding to a plurality of different stimuli points, thereby creating a set of differential-images for the network to work on for each sample-image 512a, 512b.

The eye-tracking system can receive the reference-image 510 and sample-images 512a, 512b with a large separation in time. In some examples, the reference-image may be received as part of a user calibration.

Utilizing differential imaging based on a reference-image with known reference-gaze-data for training and implementing a ML network gaze-tracking-algorithm provides two distinct benefits:
1. The important information content of the image (pupil position, glint position, iris and shape of eyelids) is enhanced making it easier for the network to learn the correct feature sets and thus improve the regression results; and
2. Spurious features or static artifacts can be effectively filtered.

The disclosed methods and systems can effectively disregard static artefacts (and other image properties such as for example image distortion) in order to identify key features (glints and pupil) in the image stream during eye tracking.

Example eye-tracking systems, as disclosed, implementing a ML network gaze-tracking-algorithm using differential-images show significant performance improvement over similar systems using normal (non-differential) training- and/or sample-images. For example, network training results using differential-training-images have shown a significant improvement in loss function. Similarly, evaluation results on test differential-images corresponding to sample-images with known gaze-data have shown a significant improvement in accuracy of gaze determination. In this way, the disclosed systems and methods can provide more accurate gaze-tracking.

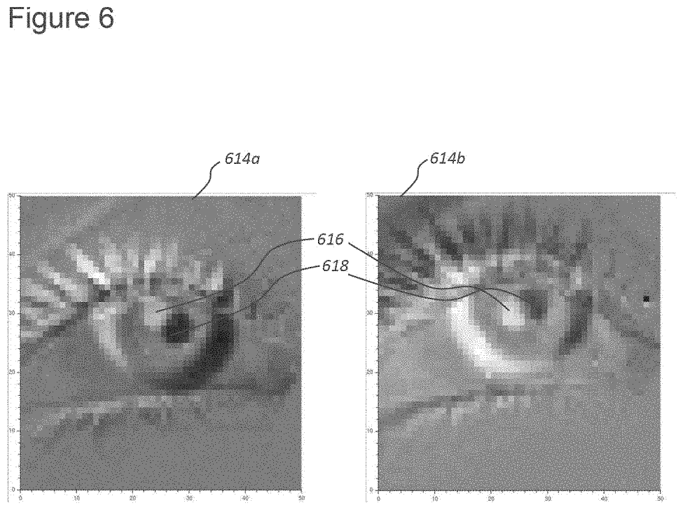

FIG. 6 illustrates two differential-images calculated by an eye-tracking system configured to determine pupil-data according to an embodiment of the present disclosure.

In this example, the reference-eye-data and the eye-data both comprise pupil-data, for example pupil-position-data and/or pupil-radius-data. The eye-tracking system receives a reference-image. The reference-image may comprise an image of an eye of a user with known pupil-data. For example, the reference-image may comprise an image of the eye of the user for which the reference-pupil-data has been determined by a pupil-detection process with a confidence-value exceeding a confidence-threshold. The reference-image may be considered as an image with a reliably detected pupil.

The eye-tracking system may perform the pupil-detection process to determine the reference-image. In other examples, the pupil-detection process may be performed by a separate system. The eye-tracking system may perform a pupil-detection process on a plurality of images of the eye of the user. The eye-tracking system may then select a reference-image based on the confidence-values of the reference-pupil-data associated with the images. The eye-tracking system may select the reference-image as the image with the highest confidence-value for its reference-pupil-data that exceeds the confidence-threshold. For example, the eye-tracking system may perform a pupil-detection process on a group of images and select the image with the highest confidence-value for pupil-position as the reference-image. In some examples, the eye-tracking system may select a plurality of reference-images. The reference-pupil-data may comprise a pupil-position and/or a pupil-radius determined by the pupil-detection-process.

The eye-tracking system receives sample-images. The eye-tracking system can define the differential-images 614a, 614b as the difference between the reference-image and a corresponding sample-image in the same way as described above.

FIG. 6 illustrates two example differential-images 614a, 614b. The example differential-images 614a, 614b have been defined as a matrix subtraction of a reference-image from a sample-image with the application of a scalar offset to avoid negative differential-intensity-values. In this way, grey pixel-locations of the illustrated differential-images correspond to minimal intensity-differences between the reference-image and sample-image. Black pixel-locations correspond to pixel-locations which are darker (lower intensity-value) in the sample-image than the reference-image. White pixel-locations correspond to pixel-locations that are brighter (higher intensity-value) in the sample-image than the reference-image.

As discussed above in relation to FIG. 5, the differential-images 614a, 614b can filter static spurious features and enhance eye-features useful for eye-tracking. In particular, the eye-tracking system can determine pupil-data of the corresponding sample-images based on features of the differential-image 614a, 614b and the reference-pupil-data associated with the reference-image. A reference-pupil-area 616 corresponding to a pupil-position in the reference-image can be identified in the differential-images 614a, 614b as a lighter (white) circular region. A sample-pupil-area 618 corresponding to a pupil-position in the sample-image can be identified in the differential-images 614a, 614b as a black circular region.

The differential-images 614a, 614b illustrated in FIG. 6 have a resolution less than a resolution of the differential-images illustrated in FIG. 5. As described above, the eye-tracking system may sample the reference-image and the sample-images before defining the differential-image such that a resolution of the differential-image 614 is less than a resolution of the sample-image. In some examples, the eye-tracking system can determine pupil-data more efficiently with a reduced resolution differential-image. The reduction in resolution can reduce computation time and memory requirements of the differential-images 614a, 614b.

In the pupil-data examples, the eye-data-analyser of the eye-tracking system may determine pupil-data by determining a candidate region of the sample-image for performing a pupil-detection process based on the differential-image 614a, 614b and the reference-pupil-data. The eye-data-analyser may perform a pupil-detection process on the candidate region of the sample-image to determine the pupil-data of the sample-image. The pupil-detection process may comprise a known pupil-detection process.

In some examples, the reference-pupil-data, associated with the reference-image, comprises the reference-pupil-area 616, which may be defined by a pupil-position and a pupil-radius. As described above, a differential-image 614a, 614b can comprise a pixel-array of differential-intensity-values representing a difference in intensity-values of corresponding pixel-locations in the reference-image and the sample-image. The eye-data-analyser may determine a candidate region of the sample-image by: (i) determining candidate-pixel-locations of the differential-image 614a, 614b based on the reference-pupil-area 616 and the differential-intensity-values; and (ii) determining the candidate region of the sample-image as a region corresponding to the candidate-pixel-locations in the differential-image 614a, 614b.

The eye-data-analyser may determine the candidate-pixel-locations as: (i) pixel-locations of the differential-image 614a, 614b that correspond to the reference-pupil-area 616 (reference-pupil-data) and have a differential-intensity-value representing substantially similar intensity-values of the pixel-location in the reference-image and the sample-image; and/or (ii) pixel-locations of the differential-image 614a, 614b that do not correspond to the reference-pupil-area 616 and have a differential-intensity-value representing a lower intensity-value of the pixel-location in the sample-image relative to the reference-image. Substantially similar intensity-values may be defined by a differential-intensity-value less than an intensity-difference-threshold.

Candidate-pixel-locations corresponding to the reference-pupil-area 616 and having a differential-intensity-value representing substantially similar intensity-values can be identified in the differential-images 614a, 614b as grey coloured pixels in an overlapping region of the reference-pupil-area 616 and the sample-pupil-area 618.

Candidate-pixel-locations not corresponding to the reference-pupil-area 616 and having a differential-intensity-value representing a lower intensity-value in the sample-image relative to the reference-image can be identified in the differential-images 614a, 614b as dark regions away from the reference-pupil-area 616, such as the non-overlapping portion of the sample-pupil-area 618 or other dark features.

The eye-data-analyser of the eye-tracking system can define candidate regions in the sample-image corresponding to the candidate-pixel-locations determined in the differential-image 614a, 614b. The eye-data-analyser may then perform a pupil-detection process on the candidate regions of the sample-image. Determining the candidate regions limits a search area for pupils in the sample-image to areas in the differential-image 614a, 614b that are either dark or where grey (unchanged) regions overlap with the reference-pupil-position.

In some examples, the pupil-data determined by the eye-tracking system is of the same type as the reference-pupil-data. For example, the pupil-data and the reference-pupil-data may both comprise a pupil-area. In some examples, the pupil-data may comprise a different type of data to the reference-pupil-data. For example, the reference-pupil-data may comprise a pupil-area, whereas the determined eye-data comprises a pupil-area, a pupil radius, a pupil circularity, pupil ellipsoid axes etc. Reference-pupil-data is used to define the candidate regions of a sample-image in which to perform a pupil detection process to determine the pupil-data. As a result, the eye-tracking system may determine pupil-data that comprises more detail or finer detail than the reference-pupil-data.

The eye-tracking system can be considered as using the differential-images 614a, 614b to limit a search area for the pupil in the sample-image. Limiting the pupil-detection process to only candidate regions can increase the pupil-detection accuracy and/or reduce computational requirements.

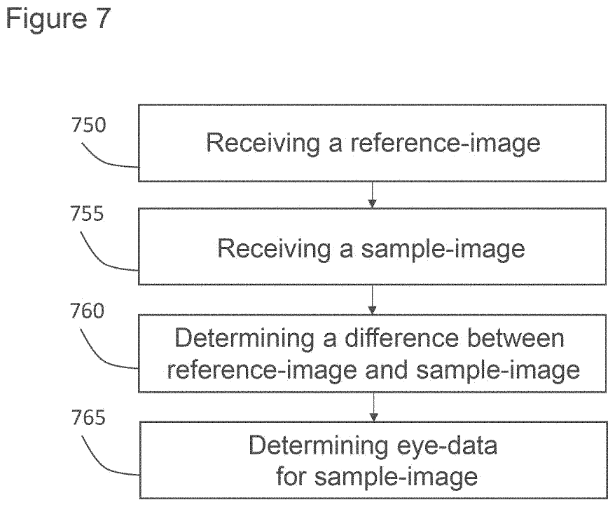

FIG. 7 illustrates a process flow of a method that may be performed by the eye-tracking system of according to one or more embodiments of the present disclosure.

The method for eye tracking comprises receiving 750 a reference-image of an eye of a user, the reference-image associated with reference-eye-data. The method further comprises receiving 755 one or more sample-images of the eye of the user. The method further comprises, for each of the one or more sample-images: determining 760 a difference between the reference-image and the sample-image to define a corresponding differential-image; and determining 765 eye-data for the sample-image based on the differential-image and the reference-eye-data associated with the reference-image.

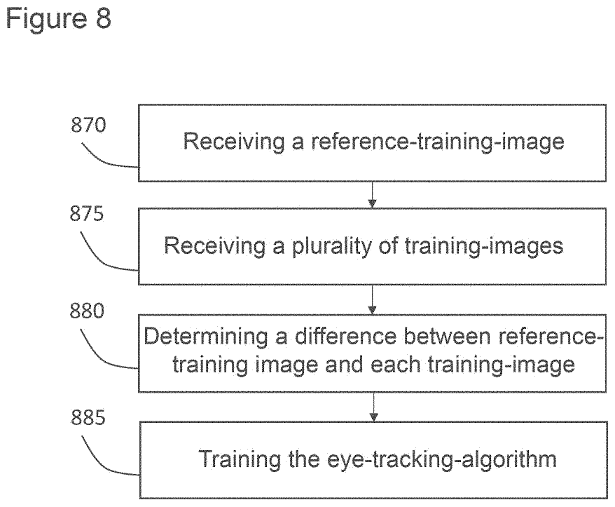

FIG. 8 illustrates a process flow of a method of providing an eye-tracking-algorithm according to one or more embodiments of the present disclosure.

The method comprises receiving 870 a reference-training-image of an eye of a user, the reference-image associated with reference-eye-data. The method further comprises receiving 875 a plurality of training-images. Each training-image is associated with training-eye-data. The method further comprises determining a difference 880 between the reference-training-image and each of the training images to define a plurality of differential-training-images. The method further comprises training 885 the eye-tracking-algorithm based on the differential-training-images, the reference-eye-data and the training-eye-data associated with the corresponding training-images.

It will be appreciated that although examples have been described with respect to FIGS. 5 and 6, the systems and methods disclosed can be applied to other examples and elements of the gaze and pupil examples disclosed may be combined. For example, the ML approach discussed in relation to FIG. 5 could be applied to pupil-data for application in a pupil-detection process based on differential-images. Such a pupil-detection process could be applied to candidate regions determined according to the examples described in relation to FIG. 5. Similarly, elements of the candidate region approach discussed in relation to FIG. 6 could be applied prior to the gaze-data determination discussed in relation to FIG. 5. In this way, the search area of differential-images could be reduced prior to determination of gaze-data.

1. An eye-tracking system configured to:
receive a reference-image of an eye of a user, the reference-image being associated with reference-eye-data;
receive one or more sample-images of the eye of the user; and
for each of the one or more sample-images:
determine a difference between the reference-image and the sample-image to define a corresponding differential-image; and
determine eye-data for the sample-image based on the differential-image and the reference-eye-data associated with the reference-image.

2. The eye-tracking system of claim 1, wherein:
the reference-eye-data comprises reference-gaze-data; and
the eye-data comprises gaze-data.

3. The eye-tracking system of claim 2, wherein:
the reference-gaze-data comprises gaze-origin-data and/or gaze-direction-data; and/or
the gaze-data comprises gaze-origin-data and/or gaze-direction-data.

4. The eye-tracking system of claim 2 wherein:
the reference-image comprises an image acquired by the eye-tracking system when a stimulus was presented to the user at a predetermined location; and
the reference-gaze-data corresponds to a gaze point associated with the predetermined location.

5. The eye-tracking system of claim 1, wherein the system is configured to determine eye-data for the sample-image using a machine learning eye-tracking-algorithm.

6. The eye-tracking system of claim 1, wherein:
the reference-eye-data comprises reference-pupil-data; and
the eye-data comprises pupil-data.

7. The eye-tracking system of claim 6, wherein:
the reference-pupil-data comprises a pupil-position and/or a pupil-radius; and/or
the pupil-data comprises a pupil-position and/or a pupil-radius.

8. The eye-tracking system of claim 6, wherein:
the reference-image comprises an image of the eye of the user for which a pupil-detection process has determined the reference-pupil-data with a confidence-value exceeding a confidence-threshold.

9. The eye-tracking system of claim 6, further configured to:
perform a pupil-detection process on one or more initial-images of the eye of the user to determine reference-pupil-data associated with each initial-image, each reference-pupil-data having an associated confidence-value; and
select the reference-image from the one or more initial-images based on the confidence-values of the pupil-data.

10. The eye-tracking system of claim 6, wherein the eye-tracking system is configured to determine the pupil-data for the sample-image based on the differential-image and the reference-pupil-data associated with the reference-image by:
determining a candidate region of the sample-image for performing a pupil-detection process based on the corresponding differential-image and the reference-pupil-data associated with the reference-image; and
performing the pupil-detection process on the candidate region of the sample-image to determine the pupil-data of the sample-image.

11. The eye-tracking system of claim 10, wherein:
the reference-pupil-data comprises a pupil-area;
the reference-image and each sample-image comprise a pixel-array of pixel-locations, each pixel-location having an intensity-value;
the eye-tracking system is configured to determine the difference between the reference-image and the sample-image by matrix subtraction of the corresponding pixel-arrays to define the differential-image as a pixel-array of differential-intensity-values; and
the eye-tracking system is configured to determine the candidate region of the sample-image by:
determining candidate-pixel-locations of the corresponding differential-image based on the pupil-area and the differential-intensity-values; and
determine the candidate region of the sample-image corresponding to the candidate-pixel-locations of the differential-image.

12. The eye-tracking system of claim 11, wherein the eye-tracking system is configured to determine the candidate-pixel-locations of the differential-image as:
pixel-locations of the differential-image that correspond to the pupil-area and have a differential-intensity-value representing substantially similar intensity-values of the pixel-location in the corresponding sample-image and the reference-image; and/or
pixel-locations of the differential-image that do not correspond to the pupil-area and have a differential-intensity-value representing a lower intensity-value of the pixel-location in the corresponding sample-image relative to the reference-image.

13. The eye-tracking system of claim 10, wherein a resolution of the differential-image is less than a resolution of the corresponding sample-image.

14. The eye-tracking system of claim 1, wherein the reference-image is one of a plurality of reference-images, each reference-image having associated reference-eye-data, and wherein the eye-tracking system is configured to:
receive the plurality of reference-images of the eye of the user; and
for each of the one or more sample-images:
determine a difference between each of the plurality of reference-images and the sample-image to define a plurality of differential-images; and
determine the eye-data for the sample-image based on the plurality of differential-images and the reference-eye-data associated with each of the plurality of reference-images.

15. The eye-tracking system of claim 14, wherein the eye-tracking system is configured to determine the eye-data for the sample-image based on the plurality of differential-images and the reference-eye-data associated with each of the plurality of reference-images by:
for each of the one or more sample-images:
determining intermediate-eye-data for each differential-image based on the differential-image and the reference-eye-data of the reference-image corresponding to the differential-image; and
calculating the eye-data based on the each intermediate-eye-data.

16. A head-mounted device comprising the eye-tracking system of claim 1.

17. A method for eye-tracking, the method comprising:
receiving a reference-image of an eye of a user, the reference-image being associated with reference-eye-data;
receiving one or more sample-images of the eye of the user; and
for each of the one or more sample-images:
determining a difference between the reference-image and the sample-image to define a corresponding differential-image;
determining eye-data for the sample-image based on the differential-image and the reference-eye-data associated with the reference-image.

18. A computer program configured to perform the method of claim 17.

19. A method of providing an eye-tracking-algorithm, the method comprising:
receiving a reference-training-image of an eye of a user, the reference-training-image being associated with reference-training-data;
receiving a plurality of training-images of the eye of the user, each training-image being associated with training-eye-data;
determining a difference between the reference-training-image and each of the training-images to define corresponding differential-training-images;
training the eye-tracking-algorithm based on the differential-training-images, the reference-training-data and the training-eye-data associated with the corresponding training-images.
